(19) United States
(12) Patent Application Publication
(10) Pub. No.: US 2014/0304236 A1
(43) Pub. Date: Oct. 9, 2014

(54) HASH VALUE GENERATION APPARATUS, SYSTEM, DETERMINATION METHOD, PROGRAM, AND STORAGE MEDIUM

(71) Applicant: CANON KABUSHIKI KAISHA, Tokyo (JP)

(72) Inventor: Hirotaka Hachiya, Yokohama-shi (JP)

(73) Assignee: CANON KABUSHIKI KAISHA, Tokyo (JP)

(21) Appl. No.: 14/242,557

(22) Filed: Apr. 1, 2014

(30) Foreign Application Priority Data
Apr. 5, 2013 (JP) 2013-079445

(51) Int. Cl. G06F 17/30

(52) U.S. Cl. CPC G06F 17/30067
USPC 707/687

(57) ABSTRACT

A hash value generation apparatus that generates a hash value for identifying unknown data as belonging to a specified class or an unspecified class, includes a generation unit configured to generate hash function information including a hash function based on a specified feature amount of data belonging to the specified class, a conversion unit configured to convert the specified feature amount into a hash value based on the generated hash function information, and a storage unit configured to store the hash value obtained by the conversion as a normal hash value in association with the hash function information.

### BACKGROUND OF THE INVENTION

1. Field of the Invention

The present invention relates to a technique for identifying unknown data.

2. Description of the Related Art

There is an abnormality detection problem for identifying whether data acquired by a sensor is abnormal. As an approach to the abnormality detection problem, there is a method for identifying determination target data as abnormal when the data deviates from data used as a determination criterion.

In Non-patent document 1, described below, a locality sensitive hash function is used as a criterion for measuring a deviation degree. More specifically, data to be measured and data to be used as a determination criterion are respectively converted into hash values using a plurality of hash functions randomly selected. The number of times the data to be determined and the data to be used as a determination criterion take the same hash value is used as the deviation degree.
(Non-patent document 1)
Locality Sensitive Outlier Detection: A ranking drive approach, Ye Wang, Srinivasan Parthasarathy, Shirish Tatikonda, The processing of 2011 IEEE 27th International Conference on Data Engineering

However, in a method discussed in the above-mentioned document, the hash functions are randomly selected. Thus, the reliability of each of the hash functions is low. To measure the deviation degree with high accuracy, many hash functions need to be used. Therefore, it takes time to measure the deviation degree.

### SUMMARY OF THE INVENTION

According to an aspect of the present invention, a hash value generation apparatus that generates a hash value for identifying unknown data as belonging to a specified class or an unspecified class, includes a generation unit configured to generate hash function information including a hash function based on a specified feature amount representing a feature amount of data belonging to the specified class, a conversion unit configured to convert the specified feature amount into a hash value based on the generated hash function information, and a storage unit configured to store the hash value obtained by the conversion as a normal hash value in association with the hash function information.

According to the specification of this application, the unknown data can be identified as belonging to the specified class with high accuracy and at high speed.

Further features of the present invention will become apparent from the following description of exemplary embodiments with reference to the attached drawings.

### BRIEF DESCRIPTION OF THE DRAWINGS

FIG. 1 illustrating an example of a configuration of an abnormality detection system using a hash value generation apparatus and an information processing apparatus according to a first exemplary embodiment.

FIG. 2 illustrates an example of information stored in a normal feature amount storage unit (specified feature amount storage unit) according to the first exemplary embodiment.

FIG. 3 illustrates an example of information stored in a hash function storage unit according to the first exemplary embodiment.

FIG. 4 illustrates an example of hash function information selected by a hash function generation unit according to the first exemplary embodiment.

FIG. 5 illustrates an example of a distance measure to be considered in a hash function generated by the hash function generation unit according to the first exemplary embodiment.

FIG. 6 illustrates an example of information stored in a normal hash value storage unit (specified hash value storage unit) according to the first exemplary embodiment.

FIG. 7 is a flowchart illustrating an example of an operation relating to hash function generation of an abnormality detection system according to the first exemplary embodiment.

FIG. 8 is a flowchart illustrating an example of an operation relating to identification of the abnormality detection system according to the first exemplary embodiment.

FIG. 9 illustrates an example of a hash function generated by the hash function generation unit according to the first exemplary embodiment.

FIG. 10 illustrates an example of an identification result obtained by an identification unit according to the first exemplary embodiment.

FIG. 11 illustrates respective average AUCs in UMN data of the abnormality detection system according to the first exemplary embodiment in a case of using a p-stable hash in Non-patent document 1 instead of the hash function generation unit according to the present exemplary embodiment.

FIG. 12 illustrates respective EERs and AUCs in UCSD data of the abnormality detection system according to the first exemplary embodiment in a case of using a p-stable hash in Non-patent document 1 instead of the hash function generation unit according to the present exemplary embodiment.

FIG. 13 illustrates an example of a configuration of an abnormality detection system using a hash value generation apparatus and an information processing apparatus according to a second exemplary embodiment.

FIG. 14 is a flowchart illustrating an example of an operation relating to hash function generation of an abnormality detection system according to the second exemplary embodiment.

FIG. 15 illustrates an example of a configuration of an abnormality detection system using a hash value generation apparatus and an information processing apparatus according to a third exemplary embodiment.

FIG. 16 illustrates an example of information stored in a normal/abnormal feature amount storage unit (specified/unspecified feature amount storage unit) according to the third exemplary embodiment.

FIG. 17 illustrates an example of information stored in a normal/abnormal hash value storage unit (specified/unspecified hash value storage unit) according to the third exemplary embodiment.

FIG. 18 illustrates a hardware configuration of a hash generation apparatus in the specification of this application.

### DESCRIPTION OF THE EMBODIMENTS

Various exemplary embodiments, features, and aspects of the invention will be described in detail below with reference to the drawings.

A first exemplary embodiment in the specification of this application will be described with reference to the drawings.

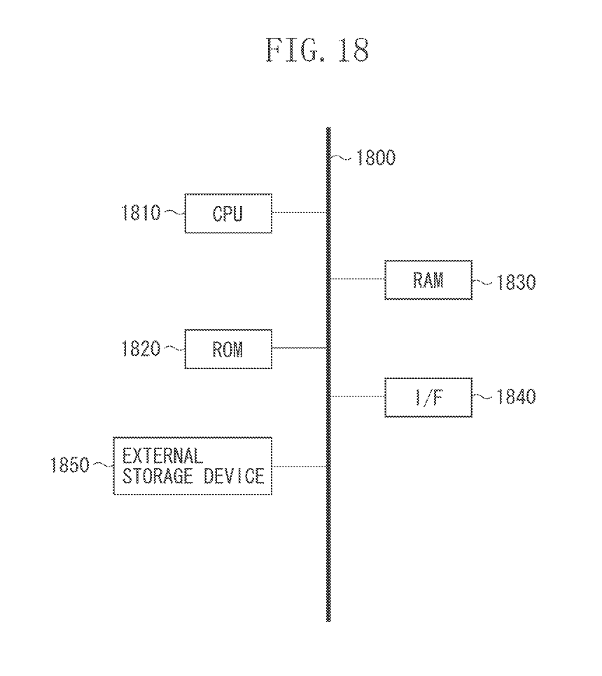

FIG. 18 illustrates a hardware configuration of a hash value generation apparatus 100 according to the present exemplary embodiment. In FIG. 18, a central processing unit (CPU) 1810 comprehensively controls devices connected via a bus 1800. The CPU 1810 reads out and executes processing steps and programs stored in a read-only memory (ROM) 1820. Processing programs and device drivers according to the present exemplary embodiment, including an operating system (OS), are stored in the ROM 1820 and temporarily stored in a random access memory (RAM) to be executed, as needed, by the CPU 1810. An interface (I/F) 1840 inputs a feature amount of video data from the information processing apparatus 200 as an input signal in a form processable by a hash value generation apparatus 100. The input feature amount is converted into a hash value in the hash value generation apparatus 100. The I/F 1840 outputs the hash value to the information processing apparatus 200. Further, a normal hash value stored in a storage area of the hash value generation apparatus 100 is output to the information processing apparatus 200.

In an abnormal detection system 1000 according to the present exemplary embodiment, an imaging apparatus 30 such as a camera images a monitoring target, and it is determined whether the monitoring target is abnormal based on video data (unknown data) obtained by the imaging. If the monitoring target is abnormal, a warning is given to a monitoring person who resides in a monitoring center such as a security office. More specifically, a specified class is referred to as a normal class, and an unspecified class is referred to as an abnormal class. The monitoring target includes an inside and outside of an ordinary household or public facilities such as a hospital and a station.

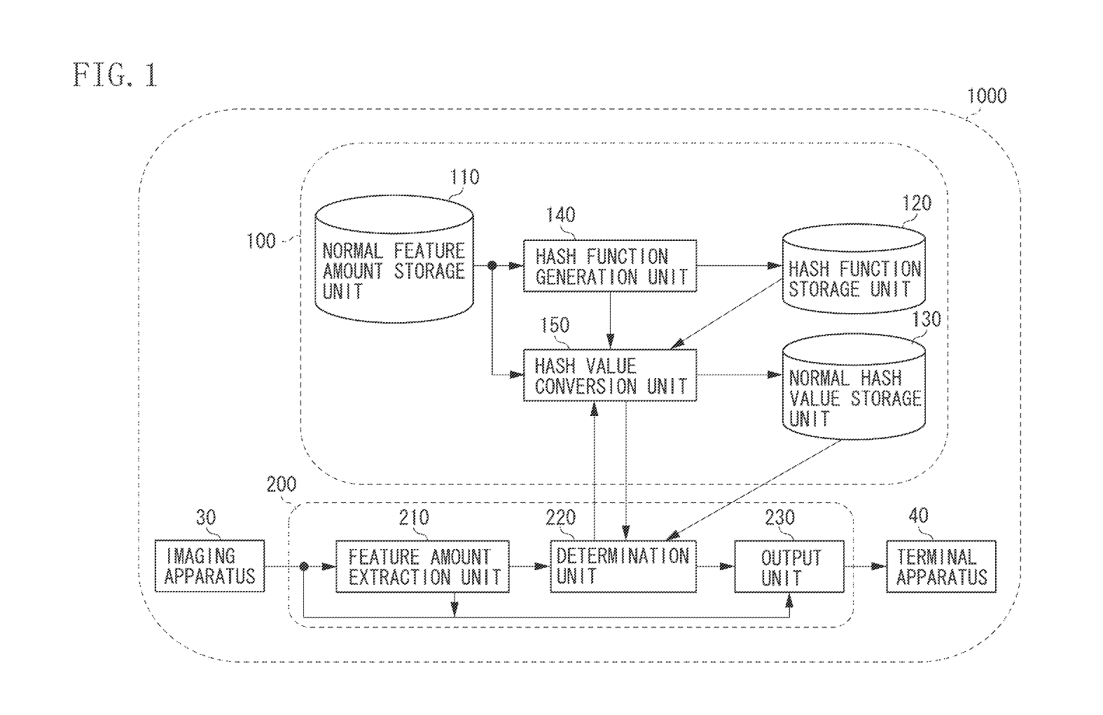

FIG. 1 is a block diagram illustrating an example of a configuration of an abnormality detection system using a hash value generation apparatus and an information processing apparatus according to an exemplary embodiment of the present invention. An abnormality detection system 1000 according to the present exemplary embodiment includes a hash value generation apparatus 100, an information processing apparatus 200, an imaging apparatus 30, and a terminal apparatus 40, which are connected to one another via a network. The network may be wired or wireless. A mobile phone line network and the Internet, for example, are applicable to the network.

A detailed configuration of the hash value generation apparatus 100 will be described below.

The hash value generation apparatus 100 generates a hash value used for identification in the information processing apparatus 200. The hash value generation apparatus 100 includes a normal feature amount storage unit (specified feature amount storage unit) 110, a hash function storage unit 120, a normal hash value storage unit (specified hash value storage unit) 130, a hash function generation unit 140, and a hash value conversion unit 150. Each of the functional units is implemented when the CPU 1810 rasterizes the program stored in the ROM 1820 to the RAM 1830 and performs processing according to each of flowcharts, described below. A hardware device may be used as an alternative to software processing using the CPU 1810. For example of such a case, a calculation unit or a circuit corresponding to processing of each of the functional units, herein described, may be used.

The normal feature amount storage unit (specified feature amount storage unit) 110 stores a normal feature amount (specified feature amount) representing a feature amount of data belonging to the normal class (specified class) in association with data ID for identifying data. The data belonging to the normal class is monitoring target video data, which has been previously confirmed to be normal by a human being. The normal feature amount is information representing a plurality of features of the monitoring target, which has been extracted using a predetermined extraction method from the video data belonging to the normal class. A feature amount extraction method will be described below in description of a feature amount extraction unit 210 included in the information processing apparatus 200.

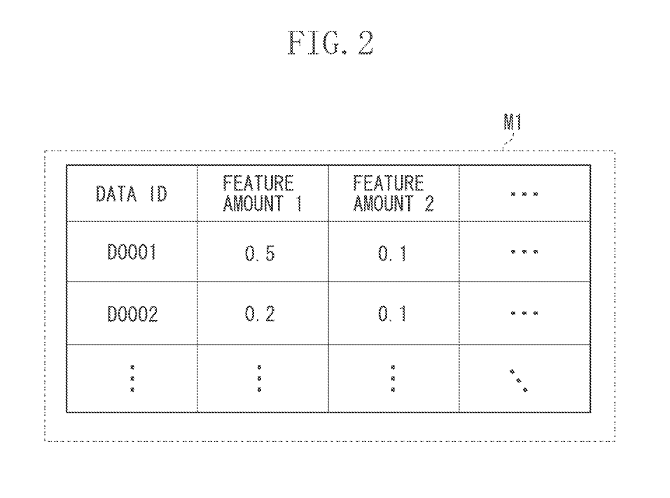

FIG. 2 is a table illustrating an example of information stored in the normal feature amount storage unit 110 according to the present exemplary embodiment. As illustrated in FIG. 2, a data identifier (ID) is a character string including an alphabet and numerals, for example. For example, two pieces of data are respectively identified by a data ID “D0001” and a data ID “D0002”. FIG. 2 indicates that values of a plurality of feature amounts, e.g., a feature amount 1 and a feature amount 2 are stored in association with the data ID.

The hash function storage unit 120 stores hash function information in association with a hash function ID for identifying the hash function. The hash function information includes one or a plurality of parameters used for the hash function, for example.

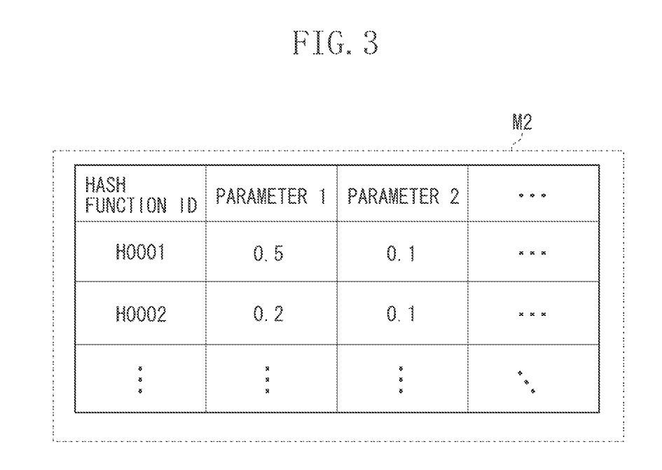

FIG. 3 is a table illustrating an example of information stored in the hash function storage unit 120 according to the present exemplary embodiment. As illustrated in FIG. 3, a hash function ID is, for example, a character string including an alphabet and numerals. For example, the first hash function and the second hash function are respectively identified by hash function IDs “H0001” and “H0002”. FIG. 3 indicates that values of parameters used for the hash function associated with hash function ID, e.g., a parameter 1 and a parameter 2 are stored.

Referring back to FIG. 1, the configuration of the hash value generation apparatus 100 will be described.

The hash function generation unit 140 generates hash function information based on the normal feature amount stored in the normal feature amount storage unit 110, and stores the generated hash function information in the hash function storage unit 120 in association with a hash function ID. More specifically, the hash function generation unit 140 reads the normal feature amount from the normal feature amount storage unit 110. The hash function generation unit 140 then generates a predetermined number of hash function information based on the read normal feature amount. The hash function generation unit 140 stores the generated hash function information in the hash function storage unit 120 in association with hash function IDs. The hash function ID is determined, for example, based on the order in which the hash function information has been generated according to the present exemplary embodiment. In this case, the hash function ID of the thirdly generated hash function is “H0003”.

The hash function generation unit 140 generates the hash function information so that the density of the normal feature amount becomes high in an area corresponding to a normal hash value (specified hash value) in a feature space. More specifically, the hash function is modeled as a hyperplane in the feature space. The feature space is a space of a feature vector having a feature amount (e.g., the feature amount 1 or the feature amount 2 illustrated in FIG. 2) in each of its elements. With the hyperplane as a boundary, a hash value of a feature vector on the side in a direction of a normal vector and a hash value of a feature vector on the opposite side are respectively “0” and “1”. For example, the m-th hash function is expressed by an equation (1):

Wₘ^{T}X−bₘ=0 (1)

T is a transpose of a vector, x is a feature vector having one feature amount in each of its elements, w is a normal vector of a hyperplane, and b is a bias parameter. More specifically, hash function information corresponds to parameters w and b. The left side of the hyperplane is termed z, as expressed by an equation (2):

z=wₘ^{T}x−bₘ (2)

z takes a positive value, if the feature vector x is on the side of the direction of the normal vector w, and z takes a negative value on the opposite side to the direction of the normal vector w. By using this nature, the hash function generation unit 140 evaluates a hash function using the following evaluation equation:

$$\frac{1}{N} {\sum }_{i = 1}^{N} L ( {w}^{T} {x}_{i} - b ) - λ b \qquad ( 3 )$$

N is the number of normal data, and λ is a bias weight parameter. L (z) is a function representing an error when normal data has been determined to be abnormal, and is defined as follows, for example:

$$L ( z ) ≡ \{ \begin{matrix}0 & ( z \geq 0 ) \\ {z}^{2} & ( z < 0 )\end{matrix} \qquad ( 4 )$$

The function L (z) has the following nature. If a normal feature vector is on the side of the direction of the normal vector w with respect to the hyperplane, L (z) takes a value of 0. On the other hand, if the normal feature vector is on the opposite side to the direction of the normal vector w with respect to the hyperplane, L (z) has a positive value proportional to a distance from the hyperplane. More specifically, when as many normal feature vectors as possible are on the side of the direction of the normal vector w with respect to the hyperplane, a value of the first term of the equation (3) is small.

On the other hand, when the bias parameter b in the second term of the equation (3) takes a value of 0, the hyperplane passes through the origin (i.e., a point where all the elements of the feature vector become 0). As the value of the bias parameter b increases, the hyperplane moves parallel in the direction of the normal vector w. On the other hand, as the value decreases (e.g., becomes a negative value), the hyperplane moves parallel in a direction opposite to the direction of the normal vector w. The bias weight parameter λ can adjust an influence degree of the bias parameter b in the second term of the equation (3) relative to the first term. The value of the bias weight parameter λ is previously set by a human being. The value of the bias weight parameter λ may be automatically set using cross validation.

The hash function generation unit 140 randomly generates sets of a predetermined number of (M) parameters w and b, to prepare hash function candidates. For example, the elements of the parameter w and the parameter b are selected according to a normal distribution and a uniform distribution. The hash function generation unit 140 selects the set of parameters w and b which minimize the equation (3), from the candidates. Thus, the hash function generation unit 140 can select a hash function in which many normal feature vectors are on the side of the direction of the normal vector w with respect to the hyperplane and the hyperplane is close to the normal feature vectors. More specifically, a hash function in which the density of a normal feature amount is high.

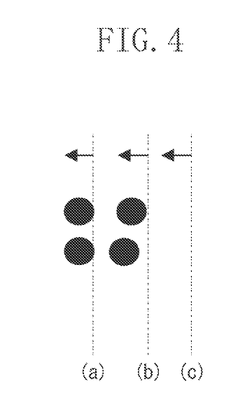

FIG. 4 illustrates an example of a hash function generated by the hash function generation unit 140 according to the present exemplary embodiment. Each of four points represents a normal feature amount in a two-dimensional feature space. Three dot lines (a), (b), and (c) are respectively candidates for a hyperplane (a straight line because the feature space is two-dimensional) corresponding to the hash function. An arrow perpendicular to the dot line represents a direction of a normal vector of the straight line. In the candidate (a), a part of normal data is on the side opposite to the hyperplane so that a value of the first term of the evaluation value (3) is large. In the candidate (c), a value of the first term of the evaluation value (3) becomes 0 but a value of the second term is large because a hyperplane stays away from normal data. On the other hand, in the candidate (b), a value of the evaluation value (3) is the minimum among the three candidates because all normal data are on the side of the direction of the normal vector with respect to hyperplane and the hyperplane is close to the normal data. Therefore, the hash function generation unit 11 selects the hyperplane (b).

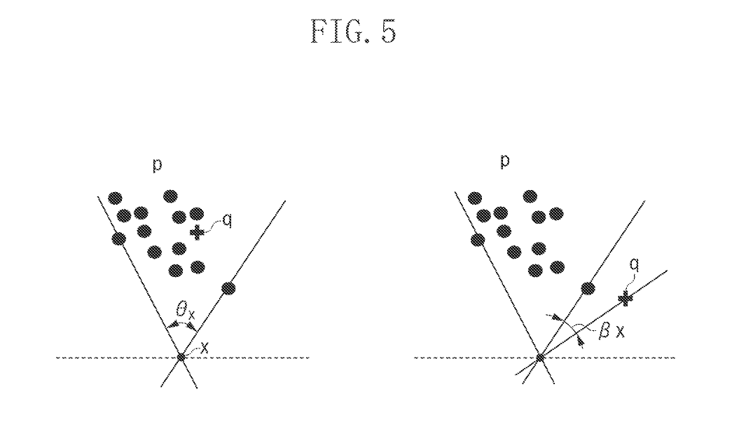

FIG. 5 illustrates an example of a distance measure to be considered in a hash function generated by the hash function generation unit 140 according to the present exemplary embodiment. p indicated by a solid circle represents a normal feature amount in a two-dimensional feature space, and a point (q) indicated by a while circle represents a video feature amount (unknown feature amount). θx represents a maximum angle between two normal feature amounts using a point x on a horizontal axis as a reference, and βx represents a minimum angle between the video feature amount and the normal feature amount. For simplicity, when the hash function generated by the hash function generation unit 140 is limited to a straight line passing through the point x, a distance measure relating to an area of normal data can be interpreted as being considered, as expressed by the following equation, in the hash function:

$${d}_{x} ( p , q ) ≡ \{ \begin{matrix}0 & if ( p , q ) ∈ ∠ {θ}_{x} \\ {β}_{x} & otherwise\end{matrix} \\ ( {θ}_{x} , {β}_{x} ) ∈ \{ 0 , π \} \qquad ( 5 )$$

The hash function satisfies the following conditions of a locality sensitive hash:

$$if {d}_{x} ( p , q ) = 0 then pr ( h ( p ) = h ( q ) ) \geq 1 - {( \frac{π + {θ}_{x}}{2 π} )}^{M} + {( \frac{π - {θ}_{x}}{2 π} )}^{M} \\ if {d}_{x} ( p , q ) \geq {β}_{x} then pr ( h ( p ) = h ( q ) ) \leq {( \frac{2 π - {β}_{x}}{2 π} )}^{M} - {( \frac{{β}_{x}}{2 π} )}^{M} \qquad ( 6 )$$

More specifically, an equation (6) indicates that the probability that two hash values (h (p) and h (q)) become equal is high when the normal feature amount and the video feature amount are within an area corresponding to the maximum angle ex. The equation (6) also indicates that the larger the minimum angle βx, the lower the probability that the two hash values become equal when the video feature amounts are not within the area corresponding to the maximum angle θx.

The hash function generation unit 14 generates a predetermined number of (L) hash function information (sets of parameters w and b) using the above-mentioned method. The hash function generation unit 140 stores the L hash function information in the hash function storage unit 120 in association with hash function IDs while outputting a conversion trigger representing start of conversion to the hash value conversion unit 150.

The normal hash value storage unit (specified hash value storage unit) 130 stores a data ID, which has been converted into a hash value by a hash function, in association with a hash function ID and the hash value.

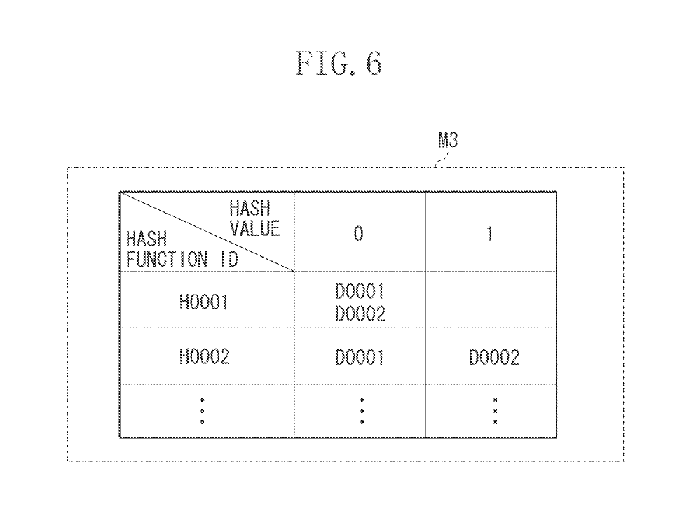

FIG. 6 is a table illustrating an example of information stored in the normal hash value storage unit 13 according to the present exemplary embodiment. As illustrated in FIG. 6, a hash value is an integer value, e.g., “0” and “1”. FIG. 6 shows that data “D0001” and data “D0002” are respectively converted into a hash value “0” by a hash function “H0001”. Further, FIG. 6 shows that the data “D0001” and the data “D0002” are respectively converted into a hash value “0” and a hash value “1” by a hash function “H0002”. A predetermined number of hash values may be joined into one hash value. When the two hash values “0” and “1” are joined to each other, for example, the hash value takes any one of four values “00”, “01”, “10”, and “11”.

Referring back to FIG. 1, a configuration of the hash value generation apparatus 100 will be described.

The hash value conversion unit 150 converts the normal feature amount stored in the normal feature amount storage unit 110 into a normal hash value based on the hash function information stored in the hash function storage unit 120. A data ID, which has been converted into a normal hash value, is stored in the normal hash value storage unit 130 in association with a hash function ID and the normal hash value. More specifically, the hash value conversion unit 150 reads the hash function ID and the hash function information from the hash function storage unit 120 (see FIG. 3) when the conversion trigger is input thereto from the hash function generation unit 140. Along with that, the hash value conversion unit 150 reads the data ID and the normal feature amount from the normal feature amount storage unit 110 (see FIG. 2). The hash value conversion unit 150 converts the read normal feature amount into a normal hash value based on the read hash function information. The hash value conversion unit 150 stores the data ID, which has been converted into the normal hash value, in the normal hash value storage unit 120 (see FIG. 6) in association with the hash function ID and the normal hash value.

The hash value conversion unit 150 inputs a video data feature amount (unknown feature amount) representing the feature amount of the video data (unknown data) from the information processing apparatus 200. The hash value conversion unit 12 outputs a video hash value (unknown hash value) obtained by converting the input video data feature amount based on the hash function information stored in the hash function storage unit 120. More specifically, the information processing apparatus 200 outputs the unknown data to the hash value conversion unit 150 via the network. In response to acquisition of the feature amount of the video data, the hash value conversion unit 150 reads the hash function information stored in the hash function storage unit 120. The hash value conversion unit 150 converts the acquired feature amount into a hash value based on the read hash function information, and outputs the hash value to the information processing apparatus 200 via the network.

A configuration of the information processing apparatus 200 will be described below with reference to FIG. 1. The information processing apparatus 200 has a similar hardware configuration to that of the hash value generation apparatus 100 illustrated in FIG. 18, and hence description thereof is not repeated. Each of functional units in the information processing apparatus 200 is implemented when the CPU 1810 rasterizes the program stored in the ROM 1820 into the RAM 1830 and performs processing according to a flowchart, described below. A hardware device can be used as an alternative to software processing implemented by the CPU 1810. In that case, for example, an operation unit or a circuit corresponding to processing of each of the functional units, herein described, may be used.

The imaging apparatus 30 includes a camera for imaging image data or video data relating to a monitoring target. The imaging apparatus 30 may include a microphone for inputting a voice of a monitoring target, a thermometer for measuring a temperature, or a distance sensor for measuring a distance. The imaging apparatus 30 transmits the acquired video data to the information processing apparatus 200 via a network.

The information processing apparatus 200 determines whether the video data, which has been imaged by the imaging apparatus 30, is abnormal. The information processing apparatus 200 includes a feature amount extraction unit 210, an identification unit 220, and an output unit 230.

The feature amount extraction unit 210 extracts a video feature amount from the video data acquired from the imaging apparatus 30. More specifically, the video data is output to the feature amount extraction unit 210 from the imaging apparatus 30 via the network at predetermined time intervals. In response to acquisition of the video data, the feature amount extraction unit 210 converts the acquired video data into a feature amount using a predetermined feature amount extraction method, and outputs the feature amount to the identification unit 220. The video data is configured in a predetermined length and at a predetermined frame rate. For example, the length of the video data is five seconds, and the frame rate is 3 fps. The feature amount extraction method includes a Histogram of Gradient (HOG), a Histogram of Optical Flow (HOF), a Multi-scale Histogram of Optical Flow (MHOF) or a Scale Invariant Feature Transform (SIFT) for extracting a local feature of each frame of the video data. The feature amount extraction method may be applied to each of a plurality of areas obtained by dividing each frame of the video data. The feature amount extraction method may be specialized to be employed in a specific monitoring target. If the monitoring target is a character, for example, a posture and a moving locus of the character may be extracted as a feature amount.

The identification unit 220 converts the video feature amount into a video hash value by the hash value conversion unit 150 included in the hash value generation apparatus 100, and identifies the video data as belonging to the normal class or the abnormal class based on the video hash value and the normal hash value stored in the normal hash value storage unit 130. The identification unit 220 outputs identification result information representing an identification result to the output unit 230. More specifically, the identification unit 220 receives the video feature amount from the feature amount extraction unit 210. The identification unit 220 converts the video feature amount into a video hash value via the hash value conversion unit 150 included in the hash value generation apparatus 100. Along with that, the identification unit 220 reads the normal hash value stored in the normal hash value storage unit 120 included in the hash value generation apparatus 100. The identification unit 220 compares the video hash value obtained by the conversion and the read normal hash value, and identifies the video data as belonging to the normal class or the abnormal class. An identification method includes two methods, for example.

As a first identification method, if there exists a hash function in which there is no normal hash value matching a video hash value, the identification unit 220 identifies the video data as belonging to the abnormal class. This means that the video data is separated from all normal data by a hyperplane corresponding to the hash function, so that the video data deviates from the normal data.

As a second identification method, if the number of times that a normal hash value and a video hash value match each other, or an average value of the number of times with respect to a hash function is lower than a predetermined threshold value, the identification unit 220 identifies the video data as belonging to the abnormal class. This means that the video data is separated from many pieces of normal data by a hyperplane corresponding to the hash function, so that the video data deviates from the normal data. The second identification method may use statistics of the number of times that a normal hash value and a video hash value match each other with respect to a plurality of video hash values. The plurality of video hash values corresponds to a plurality of areas obtained by dividing each frame of the video data, and a plurality of frames in each of the areas, for example. The statistic includes an average value and a minimum value.

The identification unit 220 outputs identification result information indicating whether the video data belongs to the normal class or the abnormal class, to the output unit 230. The identification result information takes a value of “−1” when abnormal, and takes a value of “1” when normal.

The output unit 230 generates display information relating to the video data based on the identification result information, to output the generated display information. More specifically, the output unit 23 inputs the video data and the video feature amount, respectively, from the imaging apparatus 30 and the feature amount extraction unit 210, and inputs the identification result information from the identification unit 220. The identification unit 220 generates display information relating to the input video data based on the input identification result information, and outputs the generated display information to the terminal apparatus 40 via the network. If the identification result information indicates that the video data has no abnormality (e.g., is “1”), the display information is video data as it is, or video data with a lowered resolution and frame rate, for example. On the other hand, if the identification result information indicates that the video data has an abnormality (e.g., is “−1”), the display information includes warning information to call a monitoring person's attention to the abnormality, in addition to the video data. The warning information is a text or a voice such as “there is an abnormality”. The display information may include a video feature amount which is input.

The terminal apparatus 40 is a computer apparatus used by a monitoring user, and provides the display information supplied from the information processing apparatus 200 via the network. The terminal apparatus 40 includes a display unit 41, which is not illustrated. A personal computer (PC), a tablet PC, a smartphone, and a future phone, for example, can be the terminal apparatus 40. More specifically, the terminal apparatus 40 acquires the display information in response to outputting of the display information from the information processing apparatus 200. The terminal apparatus 40 outputs the acquired display information to the display unit 41 (not illustrated).

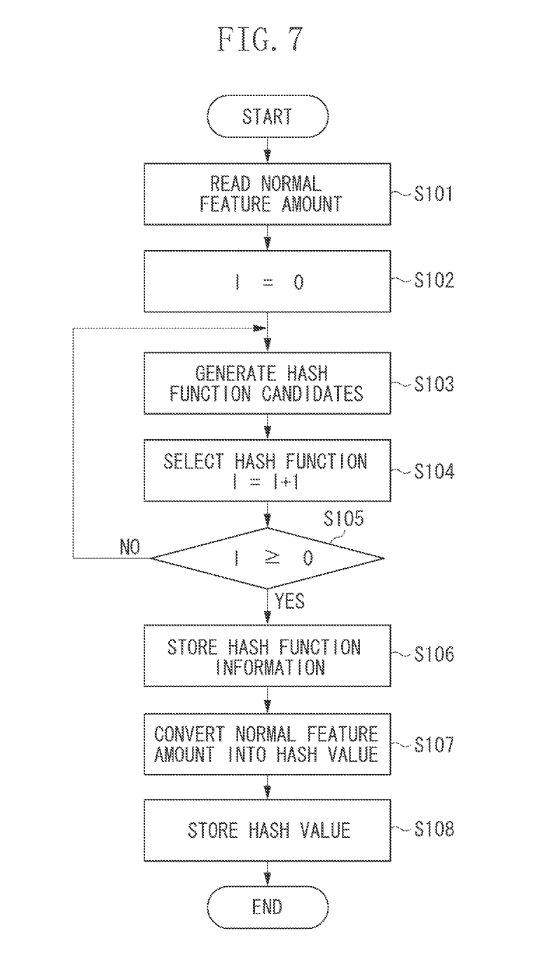

A hash function generating operation in the abnormality detection system 1000 will be described below with reference to FIG. 7. FIG. 7 is a flowchart illustrating an example of the hash function generating operation in the abnormality detection system 1000 according to the present exemplary embodiment.

First, in step S101, the hash function generation unit 140 reads a normal feature amount from the normal feature amount storage unit 110.

In step S102, the hash function generation unit 140 then sets a counter 1 representing the number of generated hash functions to “0”.

In step S103, the hash function generation unit 149 then randomly generates candidates for hash function information. More specifically, values of parameters w and b are randomly set, to generate M pieces of hash function candidates (sets of parameters w and b).

In step S104, the hash function generation unit 140 then selects the hash function. More specifically, the hash function generation unit 14 selects the hash function for minimizing the equation (3) from among M pieces of the hash function candidates. The hash function generation unit 140 adds “1” to the counter 1.

In step S105, the hash function generation unit 140 then determines whether the counter 1 is a predetermined number L or more of hash functions. If the counter 1 is the predetermined number L or more of pieces of hash functions (YES in step S105), the processing proceeds to step S106. If the counter 1 is less than the predetermined number L of pieces of hash functions (NO in step S105), the processing returns to step S103.

In step S106, the hash function generation unit 140 then stores the generated hash function information. More specifically, the hash function generation unit 140 stores the generated L pieces of hash function information in the hash function storage unit 120, in association with hash function IDs. Further, the hash function generation unit 140 outputs a conversion trigger to the hash value conversion unit 150.

In step S107, the hash value conversion unit 150 then converts the normal feature amount into a hash value. More specifically, the hash value conversion unit 150 reads, when the conversion trigger is input thereto from the hash function generation unit 140, the hash function ID and the hash function information from the hash function storage unit 120 (see FIG. 3). Along with that, the hash value conversion unit 150 reads a data ID and the normal feature amount from the normal feature amount storage unit 110 (see FIG. 2). The hash value conversion unit 150 converts the read normal feature amount into a hash value based on the read hash function information.

In step S108, the hash value conversion unit 150 then stores the data ID, which has been converted into a hash value, and the processing ends. More specifically, the hash value conversion unit 150 stores the data ID, which has been converted into the hash value, in the normal hash value storage unit 130 in association with the hash function ID and the hash value (see FIG. 6).

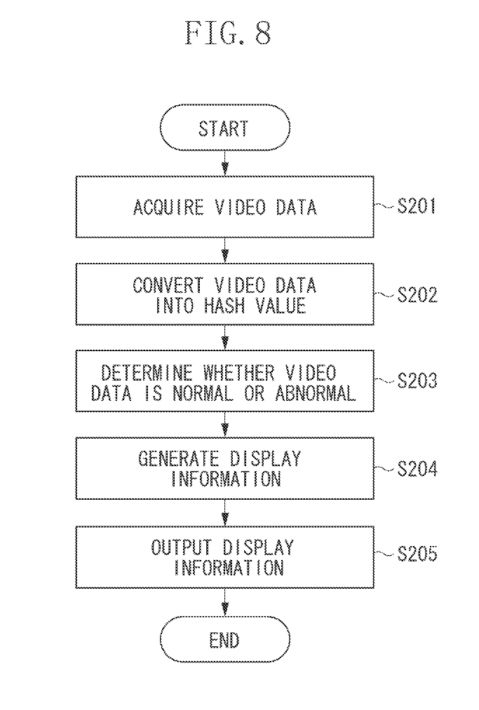

An identifying operation in the abnormality detection system 1000 will be described below with reference to FIG. 8. FIG. 8 is a flowchart illustrating an example of the identifying operation in the abnormality detection system 1000 according to the present exemplary embodiment.

First, in step S201, the feature amount extraction unit 210 acquires video data from the imaging apparatus 30 (second acquisition). More specifically, video data imaged by the imaging apparatus 30 is output to the feature amount extraction unit 210 and the output unit 230 via the network. In response to acquisition of the video data, the feature amount extraction unit 210 extracts a video feature amount from the acquired video data using a predetermined feature amount extraction method. The feature amount extraction unit 210 outputs the extracted video feature amount to the identification unit 220.

In step S202, the hash value conversion unit 150 then converts the video data into a hash value. More specifically, in response to input of the video feature amount from the feature amount extraction unit 210, the identification unit 220 outputs the video feature amount to the hash value conversion unit 150 included in the hash value generation apparatus 100. In response to input of the video feature amount from the identification unit 220 in the information processing apparatus 200 (first acquisition), the hash value conversion unit 150 reads hash function information from the hash function storage unit 120. The hash value conversion unit 150 converts the input video feature amount into a hash value based on the read hash function information, and outputs the hash value as a video hash value to the identification unit 220 in the information processing apparatus 200.

In step S203, the identification unit 220 then identifies the video data as belonging to the normal class or the abnormal class. More specifically, in response to input of the video feature amount from the hash value conversion unit 150 in the hash value generation apparatus 100, the identification unit 220 reads a normal hash value from the normal hash value storage unit 130 included in the hash value generation apparatus 100. The identification unit 220 identifies the video data as belonging to the normal class or the abnormal class based on the read normal hash value and the input video hash value. The identification unit 220 outputs identification result information representing an identification result to the output unit 230.

In step S204, the output unit 230 then outputs display information to the terminal apparatus 40. More specifically, the output unit 230 outputs the generated input identification result information and display information based on the video data input from the imaging apparatus 30, from the identification unit 220 to the terminal apparatus 40 via the network.

In step S205, the terminal apparatus 40 then outputs the display information, and the processing ends. More specifically, the terminal apparatus 40 outputs the display information input from the output unit 230 in the information processing apparatus 200 to the display unit 41 (not illustrated).

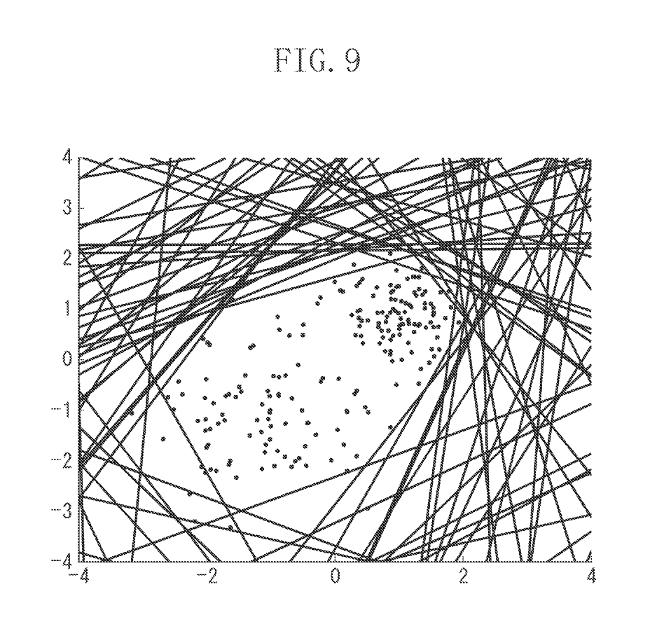

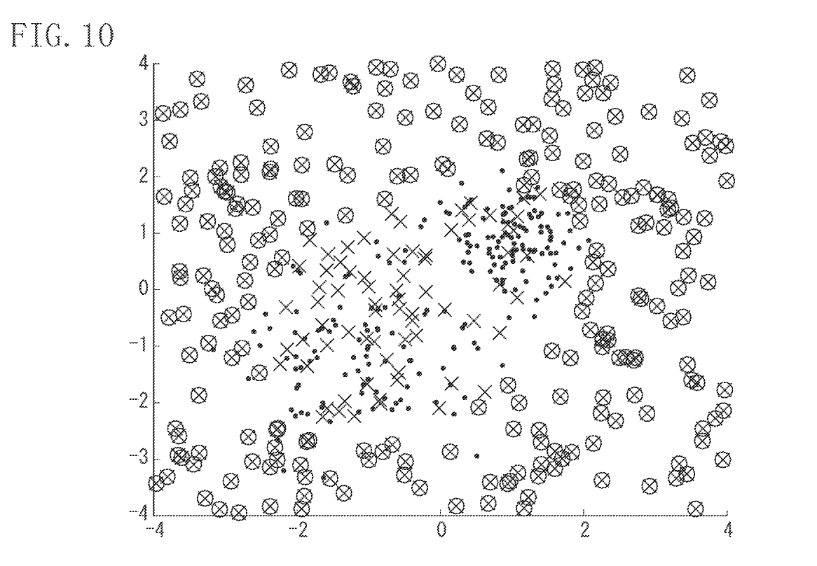

An example of abnormality detection by the abnormality detection system 1000 using artificial data will be described below with reference to FIGS. 9 and 10. FIG. 9 illustrates an example of the hash function generated by the hash function generation unit 140 according to the present exemplary embodiment. A point in the Figure represents a normal feature amount in which each dimension conforms to a Gaussian mixture distribution 0.5N (1, 0.25)+0.5N (1, 1), in a two-dimensional feature space. A line represents a hyperplane (a straight line because the feature space is two-dimensional) corresponding to L=100 hash functions selected from among M=200 hash function candidates by the hash function generation unit 11. A bias weight parameter λ is set to 0.0001. FIG. 9 indicates that the hash function generation unit 140 does not divide many normal feature amounts and selects hash functions close to the normal feature amounts.

FIG. 10 illustrates an example of a result of identification by the identification unit 22 according to the present exemplary embodiment. A point x represents a video feature amount (unknown feature amount) in which each dimension conforms to a uniform distribution U (−5, 5), in a two-dimensional feature space. A point at which a symbol x lies inside a circle, represents a video feature amount that has been identified as belonging to the abnormal class by the identification unit 22. As an identification method, if an average value of the number of times a normal hash value and a video hash value match each other with respect to a hash function, is a threshold value 199 or less, the identification unit 22 identifies the video feature amount as belonging to the abnormal class. FIG. 10 shows that the identification unit 22 identifies the video feature amount as belonging to the normal class if it exists within an area surrounded by normal data and identifies the video feature amount as belonging to the abnormal class if it exists outside the area.

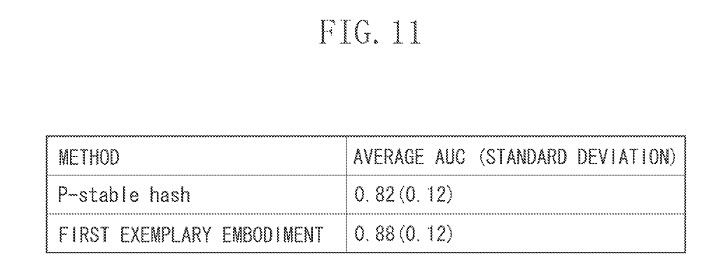

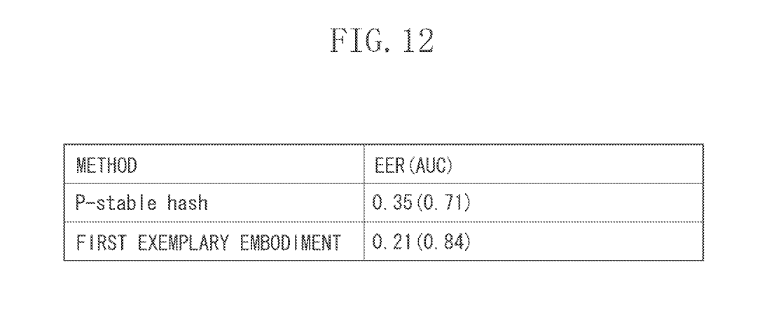

A performance evaluation of the abnormality detection system 1000 using University of Minnesota (UMN) data and University of California at San Diego (UCSD) data, which are public data, will be described below with reference to FIGS. 11 and 12.

FIG. 11 is a table showing average Area Under the Curves (AUCs) in UMN data when the abnormality detection system 1000 according to the present exemplary embodiment and a p-stable hash in Non-patent document 1 instead of the hash function generation unit 140 according to the present exemplary embodiment are used. The UMN data is video data in which a crowd of several tens of people repeatedly performs a normal “walking” action and an abnormal “running away” action a plurality of numbers of times in three different environments, which is provided at http://mha.cs.umn.edu/movies/crowdactivity-all.avi. Initial 400 frames (200 frames if the number of frames corresponding to the “walking” action is less than 400) in each repetitious action is data belonging to the normal class, and the remaining frames are unknown data.

The intensity and the direction of an optical flow are estimated from the data, and an MHOF is extracted as a normal feature amount and a video feature amount from each of 4×5 areas obtained by dividing each frame. A 1st percentile of the intensity of normal data is used as an intensity threshold value of the MHOF. In the abnormality detection system 1000 according to the present exemplary embodiment, the number of hash function candidates M is set to 1000, the number L of hash functions is set to 50, a bias weight parameter λ is set to 0.001, and the number of joints B is set to 5. In the p-stable hash, the number L of hash functions is set to 50, and the number of joints B is set to 5. If an average value corresponding to the 4×5 areas, of the number of times the normal hash value and the video hash value match each other, is lower than a threshold value, it is determined that the frame is abnormal. FIG. 11 shows that the abnormality detection system 1000 according to the present exemplary embodiment has a higher performance in abnormal behavior detection of the crowd than the p-stable hash.

FIG. 12 is a table illustrating respective Equar Error Rates (EERs) and AUCs in UCSD data of the abnormal detection system 1000 according to the present exemplary embodiment, and a case of using a p-stable hash in Non-patent document 1 instead of the hash function generation unit 140 according to the present exemplary embodiment. The UCSD data includes 34 pieces of normal video data and pieces of unknown data. While only a walker is reflected on the normal video data, objects other than the walker, e.g., a bicycle and an automobile are reflected in addition to the walker on the unknown data. UCSD data is provided at http://www.svcl.ucsd.edu/projects/anomaly/dataset.html.

As described above, the hash value generation apparatus 100 generates the hash value used in the information processing apparatus 200 for identifying the video data as belonging to the normal class or the abnormal class. The hash function generation unit 140 generates the hash function information representing the hash function based on the normal feature amount representing the feature amount of the data belonging to the normal class stored in the normal feature amount storage unit 110, and stores the generated hash function information in the hash function storage unit 120. The hash value conversion unit 150 converts the normal feature amount stored in the normal feature amount storage unit 110 into the hash value based on the hash function information stored in the hash function storage unit 120, and stores the hash value as the normal hash value in the normal hash value storage unit 130. Thus, an area of the normal feature amount can be considered in generating the hash function. Therefore, the normal hash value generation apparatus 100 can generate a highly reliable hash function as a criterion for measuring a deviation degree from normal. Further, the normal hash value generation apparatus 100 can generate a highly reliable normal hash value by using the generated hash function.

The hash function generation unit 140 in the hash value generation apparatus 100 generates the hash function information so that the density of the normal feature amount becomes higher in the area corresponding to the normal hash value on the feature space. Thus, the hash value generation apparatus 100 can generate a hash function in which normal feature amounts have the same hash value and an area on a feature space where they have the hash value is small. Thus, the hash value generation apparatus 100 can generate a highly reliable hash function capable of reducing a rate at which data belonging to the abnormal class is erroneously identified as belonging to the normal class. Further, a highly reliable normal hash value can be generated by using the hash function.

The hash value conversion unit 150 in the hash value generation apparatus 100 inputs the video feature amount representing the feature amount of the video data, converts the video feature amount into the hash value based on the hash function information stored in the hash function storage unit 120, and outputs the hash value as the video hash value. Thus, a highly reliable hash function can be used as a criterion for measuring a deviation degree from normal. Therefore, the hash value conversion unit 150 can generate a highly reliable video hash value.

In the information processing apparatus 200, the feature amount extraction unit 210 receives the video data, and extracts the video feature amount. The identification unit 22 converts the video feature amount into the video hash value via the hash value conversion unit 150, identifies whether the video data as belonging to the normal class or the abnormal class based on the normal hash value stored in the normal hash value storage unit 130 and the video hash value, and outputs the identification result information representing the identification result. The output unit 230 generates the display information relating to the video data based on the identification result, and outputs the generated display information. Thus, a small number of reliable normal hash functions are used as a criterion for measuring a deviation degree from normal. Therefore, the information processing apparatus 200 can perform identification at high speed.

A second exemplary embodiment for implementing the present invention will be described below with reference to the drawings. The same components to those in the first exemplary embodiment are assigned the same reference numerals, and hence description thereof is not repeated.

An abnormality detection system 2000 according to the present exemplary embodiment will be described using a case where normal data is added online as an example. More specifically, a hash value generation apparatus 300 according to the present exemplary embodiment differs from that in the first exemplary embodiment in that a hash function can be updated based on normal data newly added by a monitoring person. A specified class and an unspecified class are respectively referred to as a normal class and an abnormal class, like in the first exemplary embodiment.

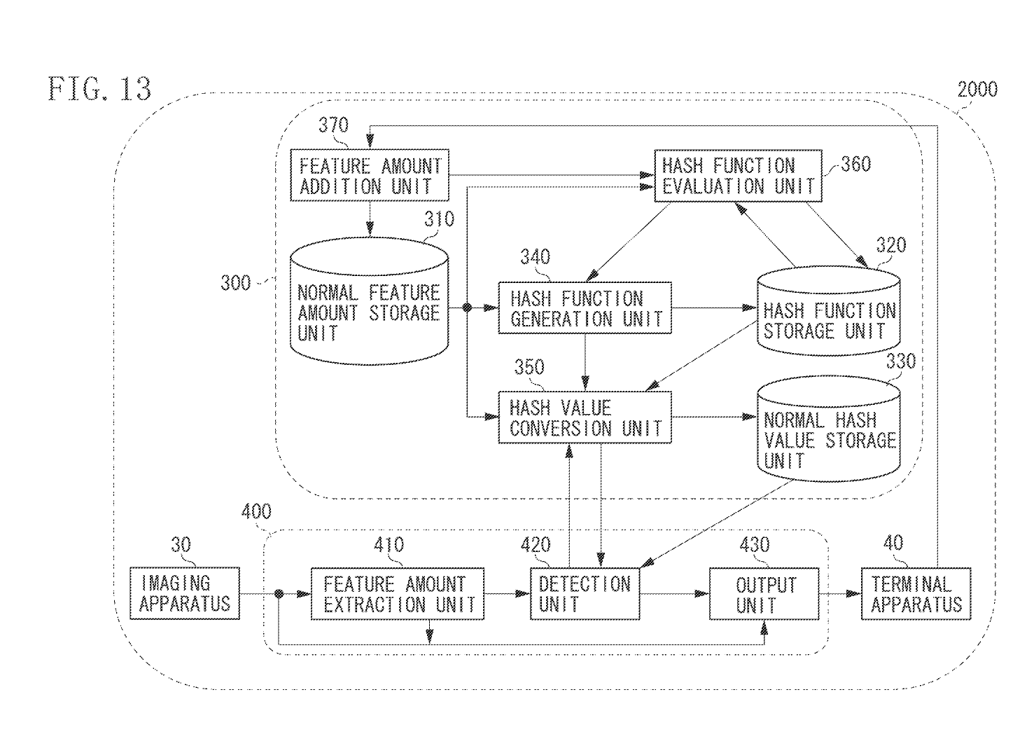

FIG. 13 illustrates a configuration of the abnormality detection system 2000 according to the second exemplary embodiment of the present invention. The normal detection system 2000 includes a hash value generation apparatus 300, an information processing apparatus 400, an imaging apparatus 30, and a terminal apparatus 40, which are connected to one another via a network. In the present exemplary embodiment, only the hash value generation apparatus 300 and the terminal apparatus 40 differ from the first exemplary embodiment, and the imaging apparatus 30 and the information processing apparatus 400 are the same as those in the first exemplary embodiment.

The terminal apparatus 40 is a computer apparatus used by a monitoring user, and provides display information to be supplied from the information processing apparatus 400 via the network. In addition, the terminal apparatus 40 adds a normal feature amount used in the hash value generation apparatus 300. The terminal apparatus 40 includes a display unit 41 and an operation detection unit 42, which are not illustrated. More specifically, the terminal apparatus 40 responds to the information processing apparatus 400 outputting the display information and acquires the display information. The terminal apparatus 40 outputs the acquired display information to the display unit 41. When the monitoring user inputs feature amount addition information indicating that a feature amount is added, the terminal apparatus 40 outputs a video feature amount included in the display information input from the information processing apparatus 400, as a normal feature amount to the hash value generation apparatus 300.

When the operation detection unit 42 in the terminal apparatus 40 detects that the monitoring user has pressed a button “add a feature amount” based on video data displayed on the display unit 41, which is not illustrated, for example, the video feature amount is output as the normal feature amount to the hash value generation apparatus 300.

A detailed configuration of the hash value generation apparatus 300 will be described below.

The hash value generation apparatus 300 generates a hash value used for identification in the information processing apparatus 400. The hash value generation apparatus 300 includes a normal feature amount storage unit 310, a hash function storage unit 320, a normal hash value storage unit 330, a hash function generation unit 340, a hash value conversion unit 350, a feature amount addition unit 370, and a hash function evaluation unit 360.

The feature amount addition unit 370 stores a normal feature amount in the normal feature amount storage unit 310. More specifically, the feature amount addition unit 370 responds to the terminal apparatus 40 outputting the video data feature amount as the normal feature amount via the network and acquires the normal feature amount. The feature amount addition unit 370 stores the acquired normal feature amount in the normal feature amount storage unit 370 in association with a data ID (see FIG. 2). Further, the feature amount addition unit 370 outputs an evaluation trigger representing start of evaluation to the hash function evaluation unit 360.

The hash function evaluation unit 360 evaluates hash function information stored in the hash function storage unit 320 based on the normal feature amount stored in the normal feature amount storage unit 310, deletes the hash function information, which is not highly evaluated, from the hash function storage unit 320, and adds new hash function information to the hash function storage unit 320 via the hash function generation unit 340. More specifically, the hash function evaluation unit 360 responds to an evaluation trigger input thereto from the feature amount addition unit 370 and reads the normal feature amount from the normal feature amount storage unit 310 while reading the hash function information from the hash function storage unit 320. The hash function evaluation unit 360 performs evaluation using a predetermined evaluation method for each hash function based on the read normal feature amount and hash function information. The evaluation method includes the following two methods.

As a first evaluation method, the hash function evaluation unit 360 calculates a value of an evaluation equation (3) for each hash function information, and determines, if the value is smaller than a predetermined threshold value, that the hash function is to be deleted.

As a second evaluation method, the hash function evaluation unit 360 calculates a value of the evaluation equation (3) for each hash function information, and determines that one or a plurality of hash functions having the minimum value is to be deleted.

The hash function evaluation unit 360 deletes hash functions having a hash function ID matching a hash function ID of the hash function, which has been determined to be deleted, from the hash function storage unit 320. Further, the hash function evaluation unit 360 outputs addition information representing information about hash functions to be added to the hash function generation unit 340. This addition information includes the number of the hash functions to be added, for example. The number of the hash functions to be added is the same as the number of the hash functions deleted by the hash function evaluation unit 360.

The hash function generation unit 340 responds to the addition information input thereto from the hash function evaluation unit 360 and generates the hash function. More specifically, the hash function generation unit 340 responds to the addition information input thereto from the hash function evaluation unit 360 and reads the normal feature amount from the normal feature amount storage unit 310. The hash function generation unit 340 generates a number of hash functions to be included in the addition information based on the input hash function information and the read normal feature amount, and stores the generated hash functions in the hash function storage unit 320 (see FIG. 3) in association with the hash function IDs. The hash function generation unit 340 generates a number of hash functions to be included in the addition information using the same method as that used by the hash function generation unit 140 described in the first exemplary embodiment, for example.

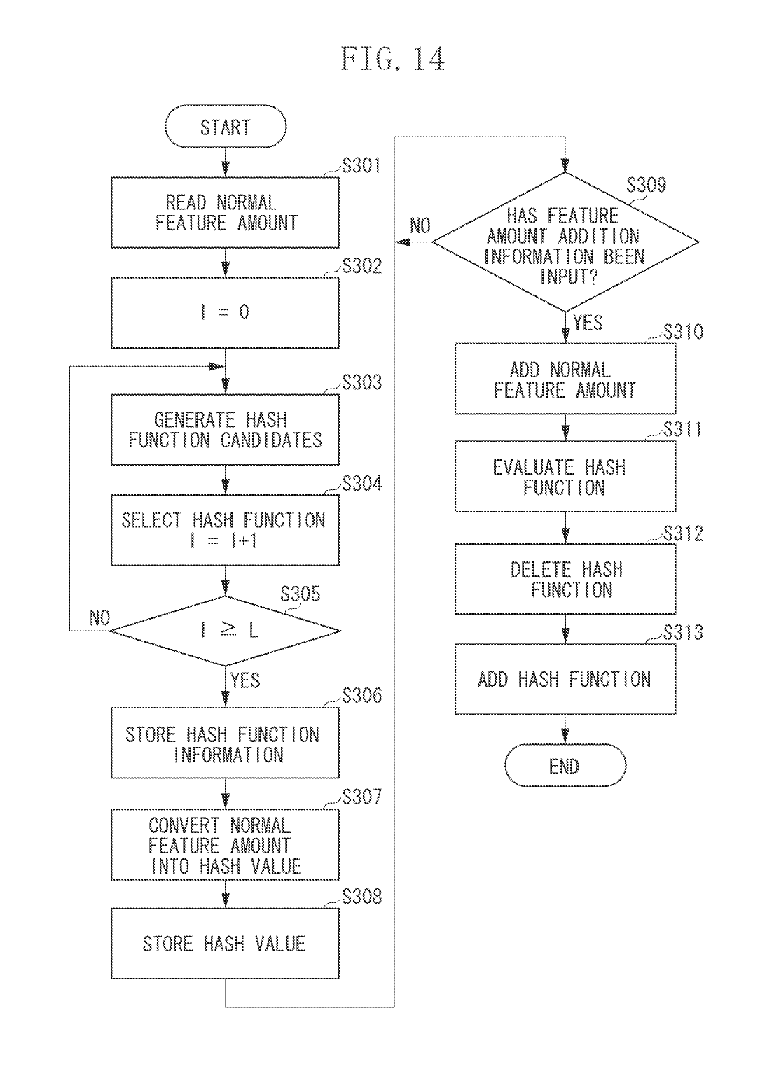

A hash function generating operation in the abnormality detection system 2000 will be described below with reference to FIG. 14. FIG. 14 is a flowchart illustrating an example of the hash function generating operation in the abnormality detection unit 2000 according to the present exemplary embodiment. Processes from step S301 to step S308 are the same as those from step S101 to S108 illustrated in FIG. 7 described in the first exemplary embodiment, and hence description thereof is not repeated.

First, in step S309, the terminal apparatus 40 responds to the monitoring user inputting feature amount addition information in the terminal apparatus 40 and outputs a normal feature amount. More specifically, in step S309, the terminal device 40 determines whether a detection unit 420 included therein has detected the input of the feature amount addition information by the monitoring user. If the input of the feature amount addition information has been detected (YES in step S309), the terminal apparatus 40 outputs a video feature amount input from the information processing apparatus 400 as a normal feature amount to the hash value generation apparatus 10, and the processing proceeds to step S310. On the other hand, if the input of the feature amount addition information has not been detected (NO in step S309), the processing returns to step S309.

In step S310, the feature amount addition unit 370 then adds a normal feature amount to the normal feature amount storage unit 310. More specifically, the feature amount addition unit 370 responds to the terminal apparatus 40 outputting the normal feature amount and acquires the normal feature amount. The feature amount addition unit 370 stores the acquired normal feature amount in the normal feature amount storage unit 310 in association with a data ID (see FIG. 2). Further, the feature amount addition unit 370 outputs an evaluation trigger to the hash function evaluation unit 360.

In step S311, the hash function evaluation unit 360 then evaluates hash functions. More specifically, the hash function evaluation unit 360 responds to the evaluation trigger input thereto from the feature amount addition unit 370 and reads the normal feature amount from the normal feature amount storage unit 310 while reading hash function information from the hash function storage unit 320. The hash function evaluation unit 360 performs evaluation using an evaluation method predetermined for each of the hash functions (e.g., the first or second evaluation method) based on the read normal feature amount and hash function information.

In step S312, the hash function evaluation unit 360 then deletes the hash function that is not highly evaluated. More specifically, the hash function evaluation unit 360 deletes from the hash function storage unit 320 the hash function having a hash function ID matching a hash function ID of the hash function that has been determined not to be highly evaluated based on the predetermined evaluation method. Addition information including the number of the deleted hash functions is output to the hash function generation unit 340.

In step S313, the hash function generation unit 340 then adds a hash function, and the processing ends. More specifically, the hash function generation unit 340 responds to the addition information input thereto from the hash function evaluation unit 360 and reads the normal feature amount from the normal feature amount storage unit 310. The hash function generation unit 340 generates a number of hash functions indicated by the addition information based on the read normal feature amount. The hash function generation unit 340 stores hash function information representing the generated hash function in the hash function storage unit 320 in association with the hash function ID.

As described above, in the hash value generation apparatus 300, the feature amount addition unit 370 adds the normal feature amount to the normal feature amount storage unit 310. The hash function evaluation unit 360 evaluates the hash function information stored in the hash function storage unit 320 based on the normal feature amount stored in the normal feature amount storage unit 310, deletes the hash function information, which is not highly evaluated, from the hash function storage unit 320, and outputs addition information representing information about the hash function to be added, to the hash function generation unit 340. The hash function generation unit 340 generates the hash function information based on the addition information, and stores the generated hash function in the hash function storage unit 320. Therefore, even if normal data is newly added, all the hash functions need not be generated again. Thus, the hash value generation unit 300 can update the hash function at high speed.

A third exemplary embodiment for implementing the present invention will be described below with reference to the drawings. The same components as those in the first exemplary embodiment are assigned the same reference numerals, and hence description thereof is not repeated.

An abnormality detection system 3000 according to the present exemplary embodiment will be described using a case where feature amounts of a small number of abnormal data are given as trailing data in addition to normal data as an example. More specifically, a hash value generation apparatus 500 according to the present exemplary embodiment differs from the first exemplary embodiment in that a hash function can be selected based on a feature amount of abnormal data in addition to normal data. In the third exemplary embodiment, a specified class and an unspecified class are respectively referred to as a normal class and an abnormal class, like in the first and second exemplary embodiments.

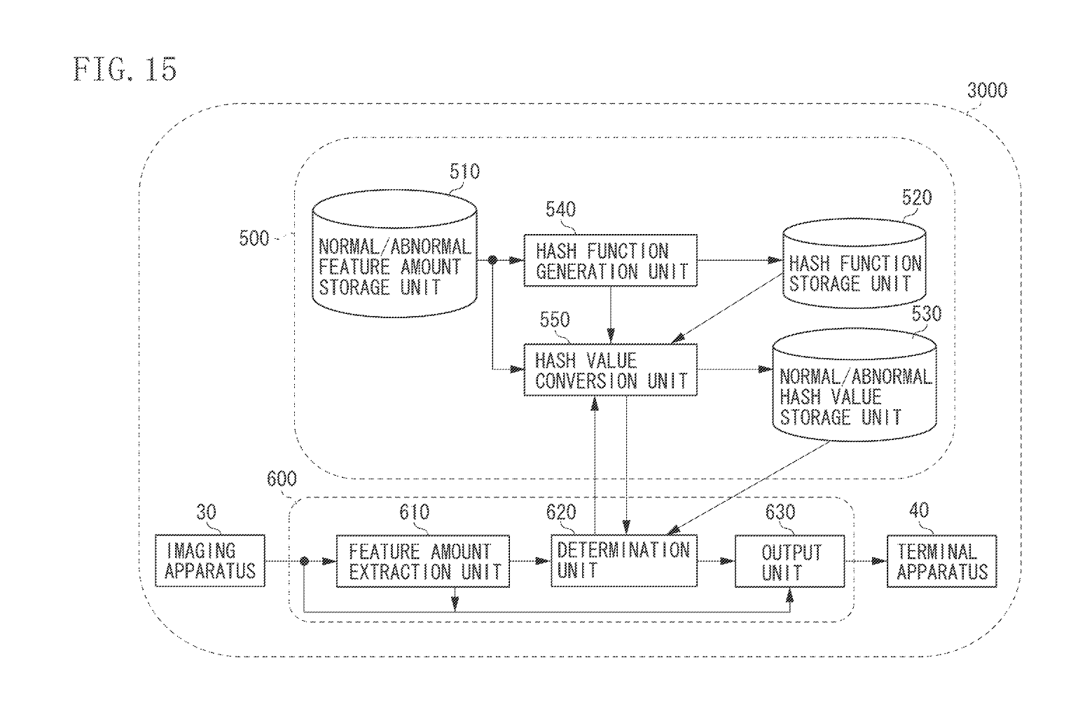

FIG. 15 illustrates an example of a configuration of the abnormality detection system 3000 according to the third exemplary embodiment of the present invention. The abnormality detection system 3000 includes a hash value generation apparatus 500, an information processing apparatus 600, an imaging apparatus 30, and a terminal apparatus 40, which are connected to one another via a network.

A detailed configuration of the hash value generation apparatus 500 will be described below.

The hash value generation apparatus 500 generates a hash value used for identification in an identification unit 620 in the information processing apparatus 600. The hash value generation apparatus 500 includes a normal/abnormal feature amount storage unit (specified/unspecified feature amount storage unit) 510, a hash function storage unit 520, a normal/abnormal hash value storage unit (specified/unspecified hash value storage unit) 530, a hash function generation unit 540, and a hash value conversion unit 550.

The normal/abnormal feature amount storage unit (specified/unspecified feature amount storage unit) 510 stores class information representing a class to which data belongs and a feature amount of the data in association with a data ID for identifying the data. The class information representing a class is information indicating that the data belongs to either one of the normal class and the abnormal class previously determined by a human being.

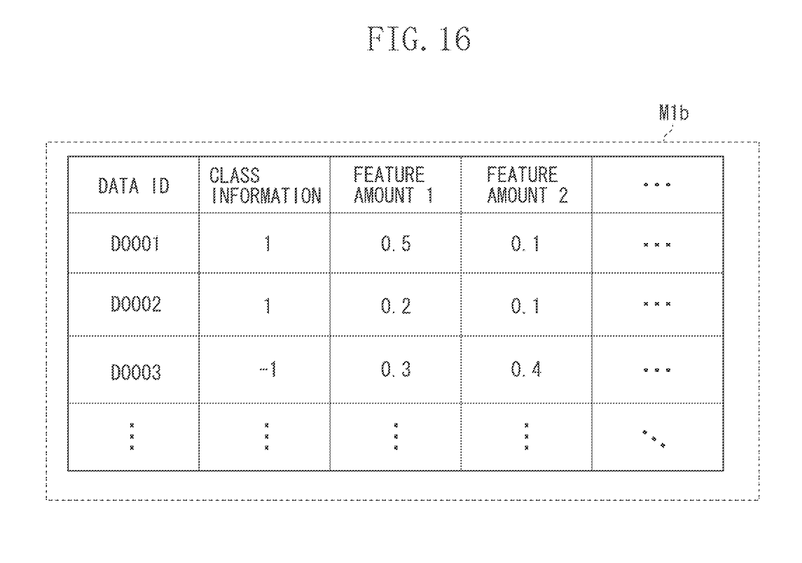

FIG. 16 is a table illustrating an example of information stored in the normal/abnormal feature amount storage unit 510 according to the present exemplary embodiment. As illustrated in FIG. 16, a data ID is a character string including an alphabet and numerals, for example. Class information takes a numerical value “1” or “−1”. “1” represents the normal class, and “−1” represents the abnormal class. FIG. 16 shows that data “D0001” and data “D0002” belong to the normal class “1”, and data “D0003” belongs to the abnormal class “−1”. Further, FIG. 16 shows that values of feature amounts associated with the data ID, e.g., a feature amount 1 and a feature amount 2 are stored.

The hash function generation unit 540 generates hash function information based on an abnormal feature amount (unspecified feature amount) representing a feature amount of data belonging to the abnormal class in addition to a normal feature amount stored in the normal/abnormal feature amount storage unit 510, and stores the generated hash function information in the hash function storage unit 520. More specifically, the hash function generation unit 500 reads the normal feature amount and the abnormal feature amount from the normal/abnormal feature amount storage unit 510. The hash function generation unit 540 generates a predetermined number L of hash function information based on the read normal feature amount and abnormal feature amount. The generated hash function information is stored in the hash function storage unit 520 in association with hash function IDs.

The hash function generation unit 540 generates the hash function information such that the normal feature amount and the abnormal feature amount respectively take different hash values and the density of the normal feature amount becomes higher in an area corresponding to a normal hash value on a feature space. The hash function generation unit 540 differs from the hash function generation unit 540 described in the first exemplary embodiment in that the evaluation equation (3) is replaced with the following evaluation equation:

$$\frac{Nn}{N} {\sum }_{i = 1}^{N p} L ( {w}^{T} {x}_{i} - b ) + \frac{N p}{N} {\sum }_{i = 1}^{Nn} L ( - ( {w}^{T} {x}_{i} - b ) ) - λ b \qquad ( 7 )$$

Np is the number of normal data, Nn is the number of abnormal data, and N is a total of Np and Nn. More specifically, the first term and the third term have the same nature as that of the first term of the evaluation equation (3). In the second term, if a feature vector of the abnormal data is on the opposite side to a direction of a normal vector of a hyperplane, a value of L (−z) becomes zero. On the other hand, if the feature vector is on the side of the direction of the normal vector of the hyperplane, L (−z) has a positive value proportional to a distance from the hyperplane. More specifically, if the hyperplane is selected as many as possible such that out of a plurality of abnormal vectors, abnormal vectors are on the opposite side to the normal vector of the hyperplane, a value of the second term of the equation (7) can be made smaller. Nn/N and Np/N, which are coefficients of the first term and the second term, are respectively used to adjust influence of the terms to cope with a case where the number Nn of abnormal data is smaller than the number Np of abnormal data.

The normal/abnormal hash value storage unit (specified/unspecified hash value storage unit) 530 stores a data ID, which has been converted into a hash value according to a hash function, in association with a hash function ID, a hash value, and class information.

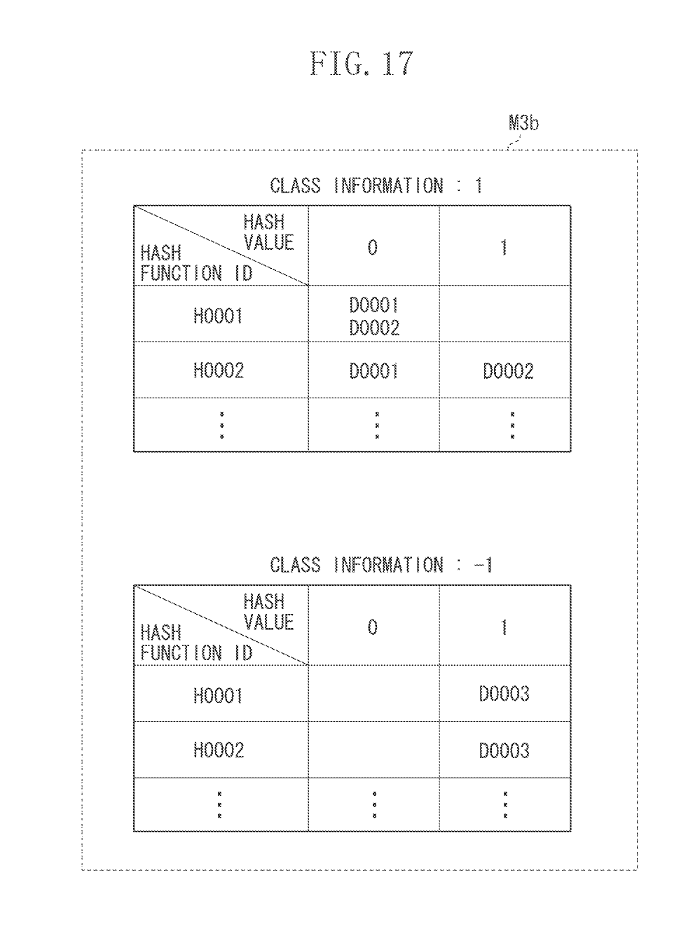

FIG. 17 is a table representing an example of information stored in the normal/abnormal hash value storage unit 530 according to the present exemplary embodiment. As illustrated in FIG. 17, there is a table for each label of a class indicated by class information. For example, in a table illustrating class information “1”, data IDs “D0001” and “D0002” belonging to a class “1” are stored in association with a hash function ID and a hash value. In a table illustrating a class information “−1”, a data ID “D0003” belonging to a class “−1” is stored in association with a hash function ID and a hash value.

The hash value conversion unit 550 stores a normal hash value and an abnormal hash value obtained by converting the normal feature amount and the abnormal feature amount stored in the normal/abnormal feature amount storage unit 510, in the hash value storage unit 520 based on the hash function information stored in the hash function storage unit 520. More specifically, the hash value conversion unit 550 reads the hash function information from the hash function storage unit 520 (see FIG. 15) when a conversion trigger is input thereto from the hash function generation unit 540. The hash function conversion unit 550 then reads the normal or abnormal feature amount from the normal/abnormal feature amount storage unit 510 (see FIG. 15), and converts the read normal or abnormal feature amount into a hash value using a hash function. The hash value conversion unit 550 stores a data ID, which has been converted into a hash value, in the normal/abnormal hash value storage unit 530 in association with a hash function ID, a hash value, and class information (see FIG. 17).

The information processing apparatus 600 identifies video data imaged by the imaging apparatus 30 as normal or abnormal. The information processing apparatus 600 includes a feature amount extraction unit 610, an identification unit 620, and an output unit 630.

The identification unit 620 converts a video feature amount into a video hash value (unknown hash value) via the hash value conversion unit 550, identifies the video data as belonging to the normal class or the abnormal class based on the normal hash value and the abnormal hash value stored in the hash value storage unit 520 and the video hash value, and outputs identification result to the output unit 630. More specifically, the identification unit 620 receives the video feature amount from the feature amount extraction unit 610. The identification unit 620 converts the input video feature amount into a video hash value via the hash value conversion unit 550 included in the hash value generation apparatus 500. Further, the identification unit 620 reads the normal hash value and the abnormal hash value stored in the hash value storage unit 520 included in the hash value generation apparatus 500. The identification unit 620 compares the video hash value with the read normal hash value and abnormal hash value, and identifies the video data as belonging to the normal class or the abnormal class. An identification method includes the following two methods.

As a first identification method, if there exists a hash function in which there is no normal hash value matching a video hash value, the identification unit 620 identifies the video data as belonging to the abnormal class. This means that the video data is separated from all normal data by a hyperplane corresponding to the hash function so that the video data deviates from the normal data.

As a second identification method, if the number of times an abnormal hash value and a video hash value match each other is more than a predetermined threshold value, the identification unit 620 identifies the video data as belonging to the abnormal class. This means that the video data cannot be separated from many abnormal data by a hyperplane corresponding to the hash function so that the video data does not deviate from the abnormal data.

A hash function generating operation and an identifying operation in the abnormality detection system 3000 are similar to those in the abnormal detection system 1000 described in the first exemplary embodiment, and hence description thereof is not repeated.

As described above, the hash value generation apparatus 500 generates the hash function information based on the normal feature amount and the abnormal feature amount stored in the normal/abnormal feature amount storage unit 510. Thus, the normal feature amount and the abnormal feature amount and their respective areas can be considered in generating the hash function information. Therefore, the hash value generation apparatus 500 can generate a highly reliable hash function as a criterion for measuring a deviation degree from normal and abnormal. Further, a highly reliable normal hash value can be generated by using the hash function.

The hash function generation unit 540 in the hash value generation apparatus 500 generates the hash function information so that the normal feature amount and the abnormal feature amount respectively take different hash values and the density of the normal feature amount becomes higher in an area corresponding to a normal hash value on a feature space. Thus, the hash value generation apparatus 500 can generate a hash function in which a normal feature amount and an abnormal feature amount respectively take different hash values and the area corresponding to the normal hash value on the feature space becomes smaller. Thus, the hash value generation apparatus 500 can generate a highly reliable hash function capable of reducing cases in which data belonging to the abnormal class is erroneously identified as belonging to the normal class. Further, a highly reliable normal hash value can be generated by using the hash function.

While the exemplary embodiments of the present invention have been described in detail above with reference to the drawings, a specific configuration is not limited to the exemplary embodiments. The present invention includes a design as long as it does not depart from the scope of the present invention. Each of the exemplary embodiments may be implemented by combining the exemplary embodiments.

While the exemplary embodiments of the present invention have been described as to an abnormality detection problem as an example, the hash value generation apparatus according to the present invention is also applicable to a general identification program without departing from the scope of the present invention. For example, the hash value generation apparatus according to the present invention is applicable to a case where a specified class is a human body and unspecified class is a class other than the human body and the human body is detected from image or video data. The information processing apparatus according to the present invention is also applicable to a multi-class identification problem by combining a hash function generated by the hash value generation apparatus according to the present invention and another hash function such as a locality sensitive hash function.

While each of the hash value generation apparatuses 100, 300, and 500 in the above-mentioned exemplary embodiments includes a hash function storage unit, a normal hash value storage unit or a normal/abnormal hash value storage unit, and a hash value conversion unit, the information processing apparatuses 200, 400, and 600 may include these units.

While an example in which each of the hash value generation apparatuses 100, 300, and 500 includes a normal feature amount storage unit or a normal/abnormal feature amount storage unit, a system may be configured such that another apparatus includes these units.

While the exemplary embodiments have been described in detail above, the present invention can be realized with an exemplary embodiment serving as a system, an apparatus, a method, a program, or a storage medium, for example. More specifically, the present invention may be applied to a system including a plurality of apparatuses, or may be applied to an apparatus including one apparatus.

Each of the units included in each of the apparatuses may be implemented by dedicated hardware devices. Alternatively, each of the units included in each of the apparatuses may be constituted by a memory and a CPU, and a function of each of the units included in each of the apparatuses may be implemented by loading a program for implementing the function into a memory and executing the program.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-079445 filed Apr. 5, 2013, which is hereby incorporated by reference herein in its entirety.

What is claimed is:

1. A hash value generation apparatus that generates a hash value for identifying unknown data as belonging to a specified class or an unspecified class, the hash value generation apparatus comprising:
a generation unit configured to generate hash function information including a hash function based on a specified feature amount representing a feature amount of data belonging to the specified class;
a conversion unit configured to convert the specified feature amount into a hash value based on the generated hash function information; and
a storage unit configured to store the hash value obtained by the conversion as a normal hash value in association with the hash function information.

2. The hash value generation apparatus according to 1, wherein the generation unit generates the hash function information so that the density of the specified feature amount is high in a feature space.

3. The hash value generation apparatus according to 1, wherein the generation unit generates the hash function information based on the specified feature amount and an unspecified feature amount representing a feature amount of data belonging the unspecified class.

4. The hash value generation apparatus according to 3, wherein the generation unit generates the hash function information so that the specified feature amount and the unspecified feature amount representing the feature amount of the data belonging to the unspecified class are distributed in a separated manner in the feature space.

5. The hash value generation apparatus according to 1, further comprising:
an evaluation unit configured to evaluate the hash function information stored in the storage unit; and
an updating unit configured to update the hash function information based on a result of the evaluation unit.

6. The hash value generation apparatus according to 5, wherein the updating unit deletes the hash function information stored in the storage unit.

7. The hash value generation apparatus according to 1, wherein the conversion unit acquires an unknown feature amount representing a feature amount of the unknown data, converts the acquired unknown feature amount into a hash value based on the hash function information stored in the hash function storage unit, and outputs the hash value as an unknown hash value.

8. A system comprising the hash value generation apparatus according to 1, and an information processing apparatus connected to the hash value generation apparatus, wherein
the hash value generation apparatus further includes a first acquisition unit configured to acquire a feature amount from the information processing apparatus,
the conversion unit converts the acquired feature amount into a hash value using the hash function information stored in the storage unit and outputting the hash value as an unknown hash value,
the information processing apparatus includes
a second acquisition unit configured to acquire unknown data,
an extraction unit configured to extract a feature amount from the acquired unknown data,
a second acquisition unit configured to acquire the unknown hash value obtained by the conversion and the normal hash value from the hash value generation apparatus, and
a determination unit configured to determine whether the unknown data belongs to the specified class based on the acquired unknown hash value and normal hash value.

9. The system according to claim 8, wherein
the information processing apparatus further includes
an imaging unit configured to image the unknown data, and
an output unit configured to output a result of the determination.

10. A method for generating a hash value for identifying unknown data as belonging to a specified class or an unspecified class, the method comprising:
generating hash function information including a hash function based on a specified feature amount representing a feature amount of data belonging to the specified class;
converting the specified feature amount into a hash value based on the generated hash function information; and
storing the hash value obtained by the conversion as a normal hash value in association with the hash function information.

11. A determination method in a system comprising a hash value generation apparatus, and an information processing apparatus connected to the hash value generation apparatus, the method comprising:
an acquisition unit in the information processing apparatus acquiring unknown data;
an extraction unit in the information processing apparatus extracting a feature amount from the acquired unknown data;
a conversion unit in the hash value generation apparatus acquiring the extracted feature amount from the information processing apparatus, and converting the acquired feature amount into an unknown hash value using a hash function;
a determination unit in the information processing apparatus acquiring the unknown hash value obtained by the conversion and a normal hash value obtained by converting a feature amount of data belonging to a specified class using the hash function, and determining whether the unknown data belongs to the specified class based on the acquired unknown hash value and normal hash value.

12. A storage medium storing a program for causing a computer to function as each of the units in the hash value generation apparatus according to claim 1.
